(19) United States
(12) Patent Application Publication
(10) Pub. No.: US 2012/0266106 A1
(43) Pub. Date: Oct. 18, 2012

(54) METHOD AND SYSTEM FOR MULTI-LEVEL BROWSING

(76) Inventor: Pugazendhi Asaimuthu, Sterling, VA (US)

(21) Appl. No.: 13/085,545

(22) Filed: Apr. 13, 2011

(51) Int. Cl. G06F 3/048

(52) U.S. Cl. 715/835

(57) ABSTRACT

A method and system for allowing an individual to quickly browse and select a particular software program application and file. Each of the software programs, applications and files is assigned a first icon as well as a unique directory address and is provided in a first group. A second group consists of a plurality of software programs, applications and files related to each other, each grouping assigned a second icon. When the first icons are displayed, one of the software programs, applications and files assigned to a particular first icon could be chosen. If none of these first icons are chosen, at least one level of the second icons is displayed. When one of these second icons is depressed, another grouping of first icons would be displayed. The individual can alternate the display of the first and second icons until a particular software program, application or file has been chosen.

### FIELD OF THE INVENTION

The present invention relates generally to software enabled systems. More particularly, the invention relates to multi-level browsing for interacting with a display of information, resulting in quick access to particular software programs, applications or files.

### BACKGROUND OF THE INVENTION

As the number of applications, files, videos, images and audios stored by electronic devices increases, the operation, interaction and navigation of the devices via a Graphical User Interface (GUI) often presents a daunting task for users. Conventional navigation and organization of electronic devices often result in directory addresses of applications, files, videos, images and audios which may be difficult to quickly find, to execute and to interact with. As an example of organization issues experienced by conventional devices, less accessed applications may be conveniently provided via ready access, whereas applications accessed more frequently may require a multiplicity of cumbersome interactions for execution. Additionally conventional mechanisms provided for searching for an application may require several minutes for execution.

In view of the foregoing, there is a need for improved techniques for multi-level browsing for interacting with a display of information.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-F present GUI displays illustrating a multi-level browsing system for software enabled systems, in accordance with an embodiment of the present invention;

FIG. 2 illustrates a typical computer system that, when appropriately configured or designed, may serve as a computer system for which the present invention may be embodied;

FIGS. 3A-D present a flow chart illustrating a method for a multi-level browsing system for software enabled systems, in accordance with an embodiment of the present invention; and

FIGS. 4A-4H present additional GUI displays illustrating the multi-level browsing system of the present invention.

Unless otherwise indicated illustrations in the figures are not necessarily drawn to scale.

### SUMMARY OF THE INVENTION

To achieve the forgoing and other objects and in accordance with the purpose of the invention, a method and system for multi-level browsing is presented.

In one embodiment a method includes steps for organizing a plurality of directory addresses for files stored on a medium such as, but not limited to a non-transitory computer readable medium into a multi-level organization comprising groups of related software programs, applications or files as well as groups of favorite individual software programs, applications and files, steps for alternately accessing and displaying selectable items corresponding to directory addresses and selectable items corresponding to links to the groups of related software programs, applications or files, steps for recognizing a selection of a selectable item, steps for accessing and then activating an application when the recognized selection corresponds to a directory address, and steps for alternately accessing and displaying selectable items corresponding to directory addresses and displaying selectable items corresponding to links to groups for a next level, when the recognized selection corresponds to a link to a group maintained by the next level.

Each of the individual software programs, applications and files are provided with a particular icon, each of which represents each software program, application and file. Each group of related software programs, applications or files is provided with particular icons, each of which represents a particular group of software programs and files. The individual software programs, applications and files are divided, into a number of sets and the groups of related software programs, applications and files are also divided into a number of sets. The icons of a first set of individual “favorite” software programs, applications and files are provided on a first display. This first display is followed by a second display containing the icons of a first set of groups of related software programs, applications and files. The displays would then generally alternate between displaying additional sets of icons for the individual software programs, applications and files and additional sets of icons for the groups of related software programs, applications and files. Additionally, as can be appreciated, the first display could include a set of icons for the groups of related software programs, applications and files followed by a second display containing a set of icons for the individual software programs, applications and files. Additional displays will generally alternate as described hereinabove.

In another embodiment a method includes the steps of organizing a plurality of directory addresses for files stored on a medium, such as, but not limited to a non-transitory computer readable medium into a multi-level organization comprising groups of related software programs, applications or files, where a group comprises N number of directory addresses and each level of the multi-level organization is operable for maintaining a determined number of directory addresses and a determined number of links to groups, in which level one is operable for maintaining N number of directory addresses shown in a first display and N number of links to groups shown in a second display, and subsequent Mth levels are operable for maintaining N^{Mth} number of directory addresses for groups linked in the (M-1)th level and N^{Mth} number of links to groups in subsequent displays. The method includes displaying selectable items corresponding to directory addresses maintained by level one, upon a first view selection by a user, and displaying selectable items corresponding to links to groups for level one, upon a second view selection by the user. A selection of a selectable item is then recognized by depressing a button or similar device on the display, designating a particular direction, address or link to a group of addresses. An application is activated when the recognized selection corresponds to a directory address. Selectable items corresponding to additional directory addresses maintained by a next level are displayed, upon a first view selection by a user, and selectable items corresponding to links to groups for the next level are displayed, after the specific software programs, applications or files designated as a first level of “favorite” software programs, applications or files viewed by the user does not include the specific program, application or file desired by the user, and a first level of links of groups to various software programs, applications or files are also not desired by the user. At this point a second level of “favorite” software programs, applications or files are then displayed, followed by, if desired, a second level of groups to various software programs, applications or files. The display of additional levels of “favorite” software programs, applications or files would generally alternate with additional levels of links of groups to various software programs, applications or files until the desired software program, application or file is found and activated.

In another embodiment a system organizes a plurality of directory addresses, “favorite” software programs, applications or files stored on a medium, such as, but not limited to a non-transitory computer readable medium into a multi-level organization comprising links of groups, alternately displays selectable items corresponding to directory addresses and selectable items corresponding to links to groups, recognizes a selection of a selectable item, activates an application when the recognized selection corresponds to a directory address, generally alternately displaying selectable items corresponding to directory addresses and displays selectable items corresponding to links to groups for a next level, when the recognized selection corresponds to a link to a group maintained by the next level.

In every embodiment, each of the displayed addresses for a particular software program, application or file would be provided with its own specific icon. Similarly, each link of a particular group would also be provided with its own specific icon. When a particular software program, application or file is picked by the user, that particular software program, application or file would then be activated. When one of the groups of software programs, applications or files is picked, the particular icons, relating to the software programs, applications or files in that particular group would be displayed. It is noted that all of the software programs, applications or files of a particular group are related to each other. For example, all of the software programs, applications or files of one group could relate to office applications, another group could relate to internet applications and a third group could relate to games.

Furthermore, although the described embodiments illustrate a method and system in which the first screen would display icons for a first level of directory addresses, with a second screen displaying icons for a first level of groups, the first screen could display the icons for a first level of groups and the second screen could display icons for a first level of directory addresses. The display screens would then generally alternate between levels of groups and levels of “favorites” in the manner previously described.

Additionally, although the described embodiments explain a system and method with viewed screens would alternate between screens provided with icons associated with the directory addresses and screens provided with icons associated with the groups of links, this need not be the case. For example, if the first screen includes icons associated with the directory addresses, the next screen and additional screens, if desired, could also include icons associated with additional directory addresses. Similarly, if the first screen includes icons associated with groups of links, the next screen and additional screens, if desired, could also include icons associated with additional groups of links.

Other features, advantages, and objects of the present invention will become more apparent and be more readily understood from the following detailed description, which should be read in conjunction with the accompanying drawings.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A first embodiment of the present invention will be described which provides means and methods for providing multi-level browsing for interacting with a display of information as provided by a software enabled system. Non-limiting examples of devices supported include mobile phones, smartphones, PDAs (Personal Digital Assistants), tablets, wrist watches, MP3 audio players, DVD players, netbook computers and portable laptop computers. A multiplicity of levels may be supported with levels supporting selection of a multiplicity of favorites and groups. Non-limiting examples of favorites include software programs, applications, contacts, files, music, video, pictures and images.

Favorites and groups may be organized based upon volume of usage. More frequently accessed favorites and groups may be provided for ease of accessibility via navigation. Furthermore, less frequently accessed favorites and groups may be provided less accessibility via navigation. Furthermore, favorites may be organized and associated with groups. Levels may support a multiplicity of favorite and group buttons with the number of favorite and group buttons supported per level configurable based upon the size of the display area. Favorite and group buttons may be highlighted/emphasized and selected for transition to other levels of favorite and group selections. Non-limiting examples of features capable of highlight/emphasis and selection by favorite buttons include applications, display of images and/or video and playing audio. Furthermore, selection of configuring to display between favorites and groups may be supported via a switch view button. Operation may return to a previous level via a previous level button. Navigation may be exited via an exit navigation button. Navigation for selection of favorite and group buttons may be performed via up, down, left and right navigation buttons. A selection button may be provided for selecting favorite and groups for devices not supporting touch-screen capabilities. A favorite or group button may be highlighted/emphasized for distinction from other favorite and group buttons for selection purposes.

In other embodiments of the present invention, a method and system will be described which provides multi-level browsing for interacting with a display of information as provided by a software enabled system for devices supporting navigation buttons via a touch-screen. Selection of display between favorites and groups may be supported via a switch view button provided via a touch-screen mechanism. Operation may return to a previous level via a previous level button provided via a touch-screen mechanism. Navigation for selection of favorite and group buttons may be performed via up, down, left and right navigation buttons provided via a touch-screen mechanism. Highlight/emphasis of switch view button, previous level button and up, down, left and right navigation buttons may be provided.

In other embodiments of the present invention, a method and system will be described for providing multi-level browsing for interacting with a display of information as provided by a software enabled system for devices supporting navigation via verbal commands. Selection of display between favorites and groups may be supported via a switch view button provided via a verbal command. Operation may return to a previous level via a verbal command. Operation may be exited via a verbal command. Navigation for selection of favorite and group buttons may be performed via up, down, left and right verbal commands.

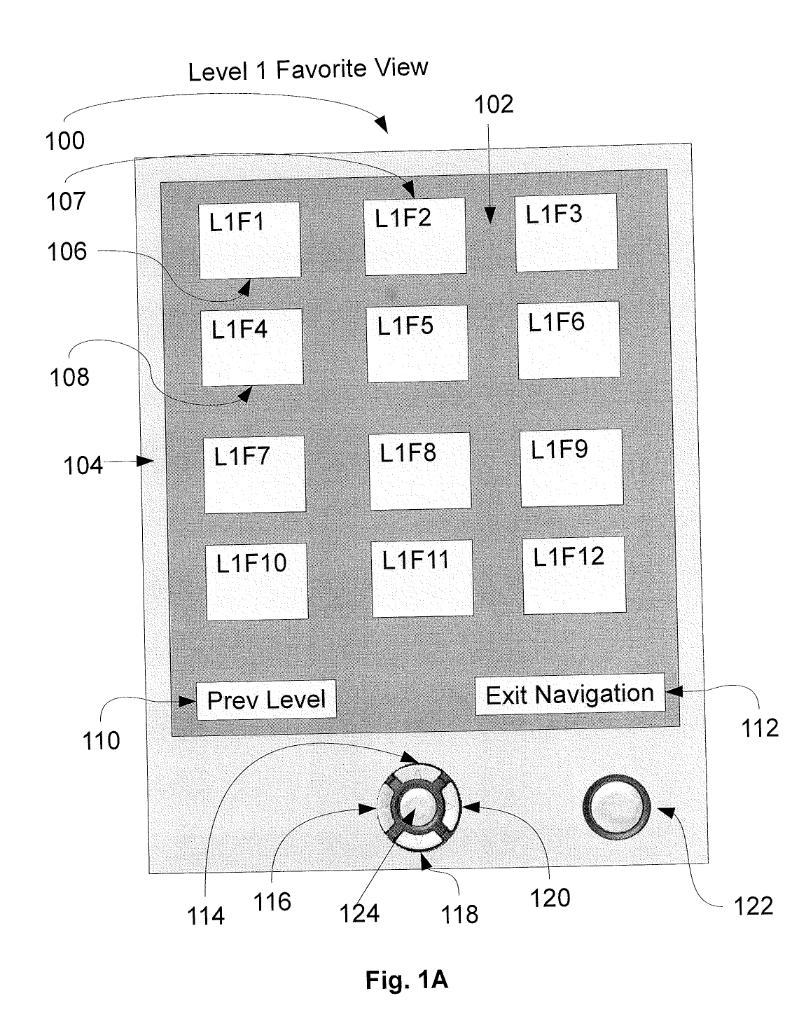

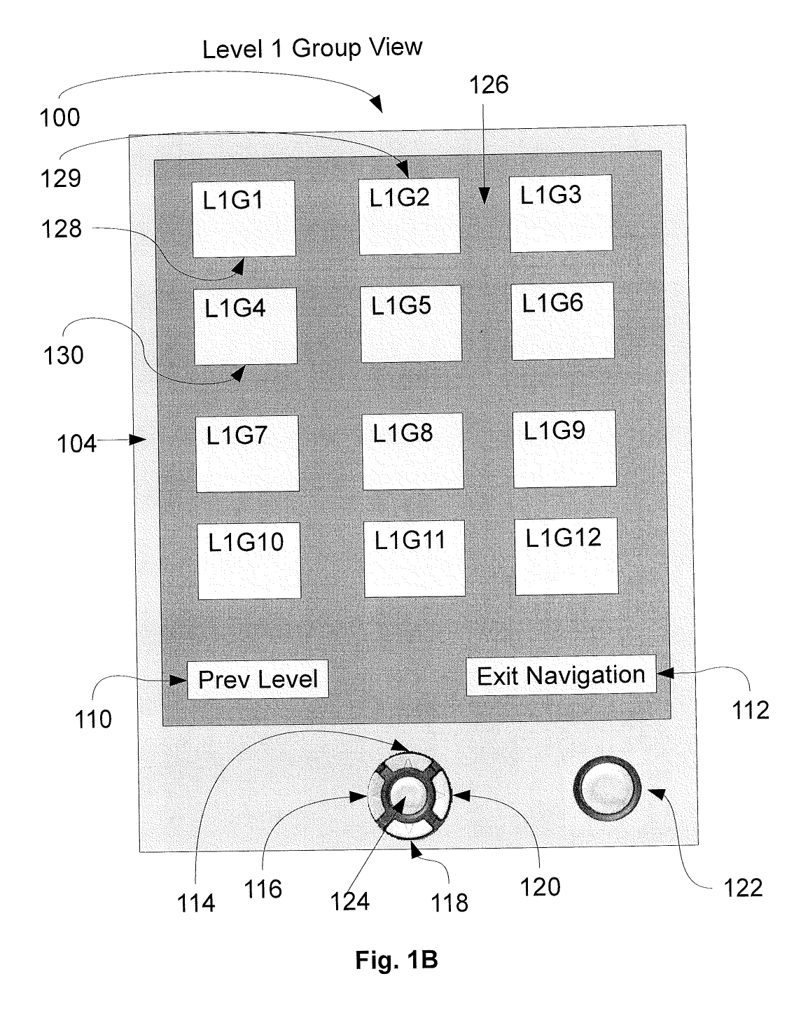

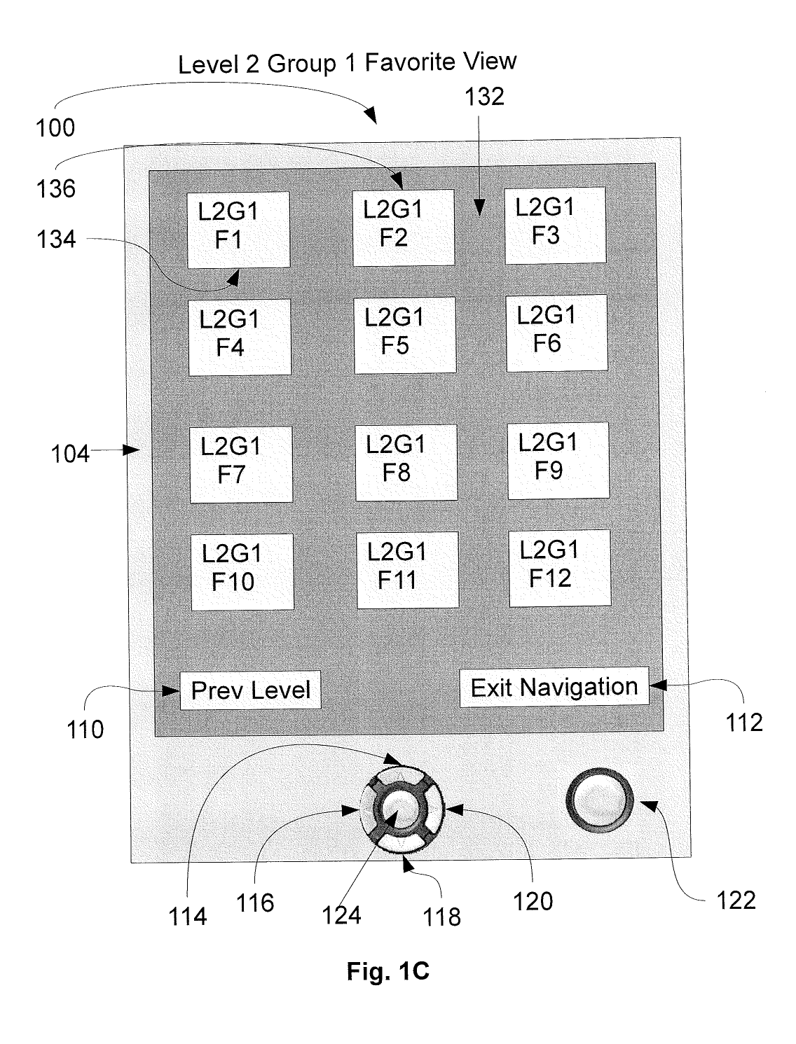

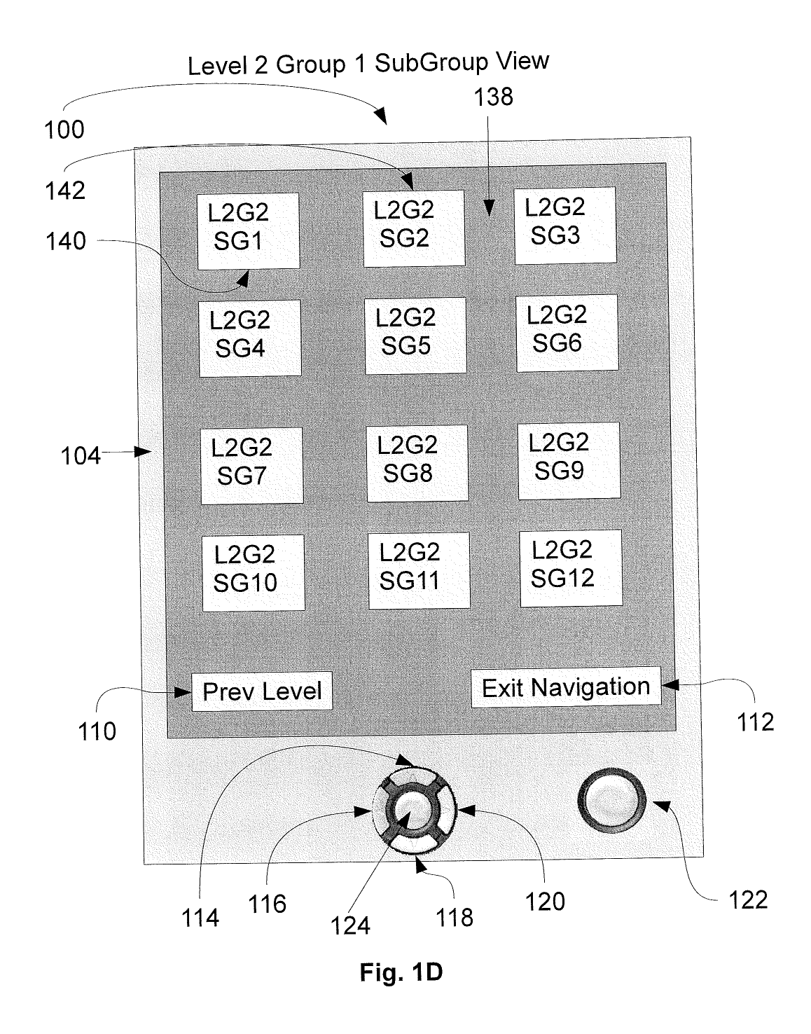

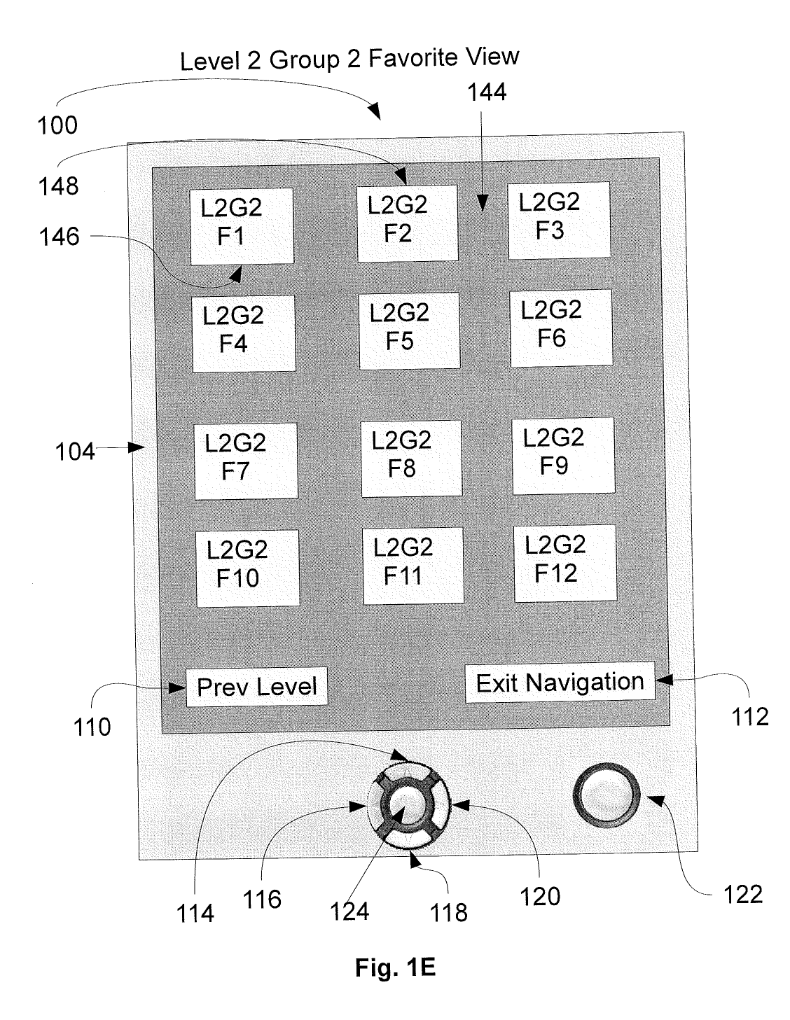

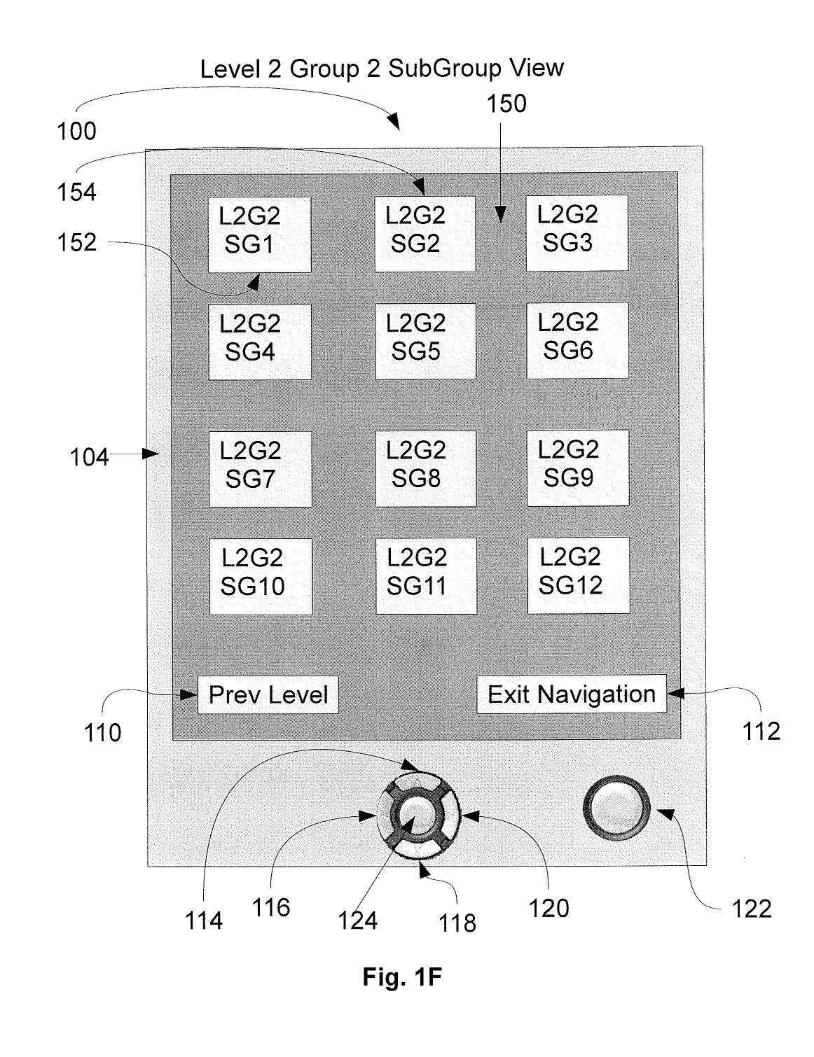

FIG. 1A presents a GUI display 100 illustrating a multi-level browsing system for software enabled systems and method thereof, in accordance with an embodiment of the present invention, showing what would generally be the first screen displayed during the operation of the present invention.

The display 100 includes a screen display portion 102 and a border portion 104.

Screen display portion 102 includes a multiplicity of favorite buttons with a sampling denoted as a favorite button 106, a favorite button 107 and a favorite button 108, a previous level button 110 and an exit navigation button 112. The exact number and placement of the buttons on the display 100 is not important. It is also noted that each of the favorite buttons could be represented by an icon and could include a written indication of the particular software program, application or file associated with each button.

Screen display portion 102 may operate to provide capability for selecting from a multiplicity of favorite buttons for transitioning to a different level for displaying information related to a selected level, for selecting to transition to a previous level and for selecting to exit navigation. As can be appreciated, if the screen shown in FIG. 1A was the first screen displayed, the previous level button 110 would be inoperable.

Buttons provided by screen display portion 102 may operate via any known means for providing buttons. Non-limiting examples for providing buttons for screen display portion 102 include hardware, software, touch-screen and verbal.

For example, a user may select favorite button 106 to activate an application for a file associated with favorite button 106, illustrated as “L1F1”, for this example. With “L1F1” indicating level one and a favorite selection one of level one. As another example, a user may select favorite button 107, illustrated as “L1F2”. With “L1F2” indicating level one and a favorite selection two of level one. Although the selection button 124 is shown to be provided between the four navigation buttons, it can also be located at any position within the border portion 104.

Border portion 104 includes an up navigation button 114, a left navigation button 116, a down navigation button 118, a right navigation button 120, a switch view button 122 and a selection button 124. Although the selection button 124 is shown to be provided between the four navigation buttons, it can also be located at any position within the border portion 104.

Border portion 104 may operate to provide capability for navigating screen display portion 102, for switching between group selections and favorite selections and for selecting to transition to a new level for display.

Buttons provided by border portion 104 may operate via any known means for providing buttons. Non-limiting examples of buttons provided by border portion 104 include hardware, software, touch-screen and verbal.

Up navigation button 114 may operate to enable a user to move the highlight or emphasis of a button presented by screen display portion 102 in the upward direction. For example, for highlight/emphasis provided for favorite button 108, a user may select to transition highlight/emphasis to favorite button 106 by selecting up navigation button 114.

Left navigation button 116 may operate to enable a user to move the highlight or emphasis of a button presented by screen display portion 102 in the leftward direction. For example, for highlight/emphasis provided for favorite button 107, a user may select to transition highlight/emphasis to favorite button 106 by selecting left navigation button 116.

Down navigation button 118 may operate to enable a user to move the highlight or emphasis of a button presented by screen display portion 102 in the downward direction. For example, for highlight/emphasis provided for favorite button 106, a user may select to transition highlight/emphasis to favorite button 108 by selecting down navigation button 118.

Right navigation button 120 may operate to enable a user to move the highlight or emphasis of a button presented by screen display portion 102 in the rightward direction. For example, for highlight/emphasis provided for favorite button 106, a user may select to transition the highlight or emphasis to favorite button 107 by selecting right navigation button 120.

Switch view button 122 may operate to provide transition between a display of favorite buttons to a display of group buttons and vice-versa, or to the next designated grouping, favorite icons, or group icons. Additional information will be provided below with respect to FIG. 1B for switch view button 122.

Selection button 124 may operate to provide selection capability for screen display portion 102 when screen display portion 102 provides display capability but does not provide touch-screen capability. For example, instead of a user selecting favorite button 107 “L1F2” as denoted by favorite button 107, a user may navigate the highlight or emphasis to favorite button 107 using up navigation button 114, left navigation button 116, down navigation button 118 and/or right navigation button 120 and then select favorite button 107 by depressing selection button 124.

FIG. 1B presents a GUI display illustrating a multi-level browsing system for software enabled systems and method thereof, in accordance with an embodiment of the present invention.

Elements of FIG. 1B previously discussed with respect to FIG. 1A will not be discussed with respect to FIG. 1B.

A screen display portion 126 includes a multiplicity of group buttons with a sampling denoted as a group button 128, a group button 129 and a group button 130, previous level button 110 and exit navigation button 112. The exact number and placement of the buttons on the display portion 126 is not important. It is noted that each of the group buttons could be represented by an icon and could include a written indication of a particular group of programs.

Screen display portion 126 may operate to provide capability for selecting from a multiplicity of group buttons for transitioning to a different level for displaying information related to a selected level, for selecting to transition to a previous level and for selecting to exit navigation.

Buttons provided by screen display portion 126 may operate via any known means for providing buttons. Non-limiting examples for providing buttons for screen display portion 126 include hardware, software, touch-screen and verbal.

For example, a user may select group button 128 to transition to the group as denoted by group button 128, illustrated as “L1G1”, for this example. With “L1G1” indicating level one and a group selection one of level one. As another example, a user may select group button 129, illustrated as “L1G2”, for this example. With “L1G2” indicating level one and a group selection two of level one. Furthermore, once a user has transitioned to another level by selecting a group button (e.g. group button 128, group button 129 and group button 130), the user may opt to return to the previous level by selecting previous level button 110. For example, once a user has transitioned to “L1G1” by selecting group button 128, the user may return to the display as illustrated by FIG. 1B by selecting previous level button 110.

Switch view button 122 may operate to provide transition between a display of favorite buttons to a display of group buttons and vice-versa or to the next designated grouping of group icons or favorite icons. For example, for a presentation as illustrated by FIG. 1B, a user may select switch view button 122 and be presented with a display of favorite buttons as illustrated by FIG. 1A. Furthermore, for a presentation of favorite buttons as illustrated by FIG. 1A, a user may select switch view button 122 and be presented with a display of group buttons as illustrated by FIG. 1B.

The nomenclature as illustrated by FIGS. 1A-B may be described as Ln where n may represent the nth level of a multi-level browsing system, Fn where n may represent the nth favorite, Gn where n may represent the nth group, LxFy where x may represent the xth level and y may represent the yth favorite, LxGy where x may represent the xth level and y may represent the yth group.

FIG. 1C presents a GUI display illustrating a multi-level browsing system for software enabled systems, in accordance with an embodiment of the present invention. This figure represents the second level of favorite software programs, applications or files.

Elements of FIG. 1C previously discussed with respect to FIG. 1A will not be discussed with respect to FIG. 1C. For example, each of the buttons shown represent specific favorite software programs, applications or files.

A screen display portion 132 includes a multiplicity of favorite buttons with a sampling denoted as a favorite button 134 and a favorite button 136, previous level button 110 and exit navigation button 112.

As an example of navigating the multi-level browsing system, the display as illustrated in FIG. 1C may be presented to a user by selection of group button 128 (FIG. 1B), denoted as “L1G1” for touch-screen devices or navigating to emphasize group button 128 followed by selection of select button 124 for non touch-screen devices.

FIG. 1D presents a GUI display illustrating a multi-level browsing system for software enabled systems, in accordance with an embodiment of the present invention.

Elements of FIG. 1D previously discussed with respect to FIG. 1A will not be discussed with respect to FIG. 1D.

A screen display portion 138 includes a multiplicity of group buttons with a sampling denoted as a group button 140 and a group button 142, previous level button 110 and exit navigation button 112.

As an example of navigating the multi-level browsing system, the display as illustrated in FIG. 1D may be presented to a user by selection of switch view button 122 in FIG. 1B.

The nomenclature as illustrated by FIGS. 1C-F may be described as Ln where n may represent the nth level of a multi-level browsing system, Fn where n may represent the nth favorite, SGn where n may represent the nth sub-group, LxFy where x may represent the xth level and y may represent the yth favorite, LxSGy where x may represent the xth level and y may represent the yth sub-group.

FIG. 1E presents a GUI display illustrating a multi-level browsing system for software enabled systems, in accordance with an embodiment of the present invention.

Elements of FIG. 1E previously discussed with respect to FIG. 1A will not be discussed with respect to FIG. 1E. This figure represents the second level of favorites for a second group.

A screen display portion 144 includes a multiplicity of favorite buttons with a sampling denoted as a favorite button 146 and a favorite button 148, previous level button 110 and exit navigation button 112.

As an example of navigating the multi-level browsing system, the display as illustrated in FIG. 1E may be presented to a user by selection of group button 129 (FIG. 1B), denoted as “L1G2”, followed by selection of select button 124 for presenting favorite buttons.

FIG. 1F presents a GUI display illustrating a multi-level browsing system for software enabled systems, in accordance with an embodiment of the present invention.

Elements of FIG. 1F previously discussed with respect to FIG. 1A will not be discussed with respect to FIG. 1F. This figure represents the third level of a second group.

A screen display portion 150 includes a multiplicity of group buttons with a sampling denoted as a group button 152 and a group button 154, previous level button 110 and exit navigation button 112.

As an example of navigating the multi-level browsing system, the display as illustrated in FIG. 1F may be presented to a user by selection of group button 129 (FIG. 1B), denoted as “L1G2”, followed by selection of switch view button 122 for presenting group buttons.

FIGS. 1A-1F present an illustration of a multi-level browsing system and navigation of the multi-level browsing system.

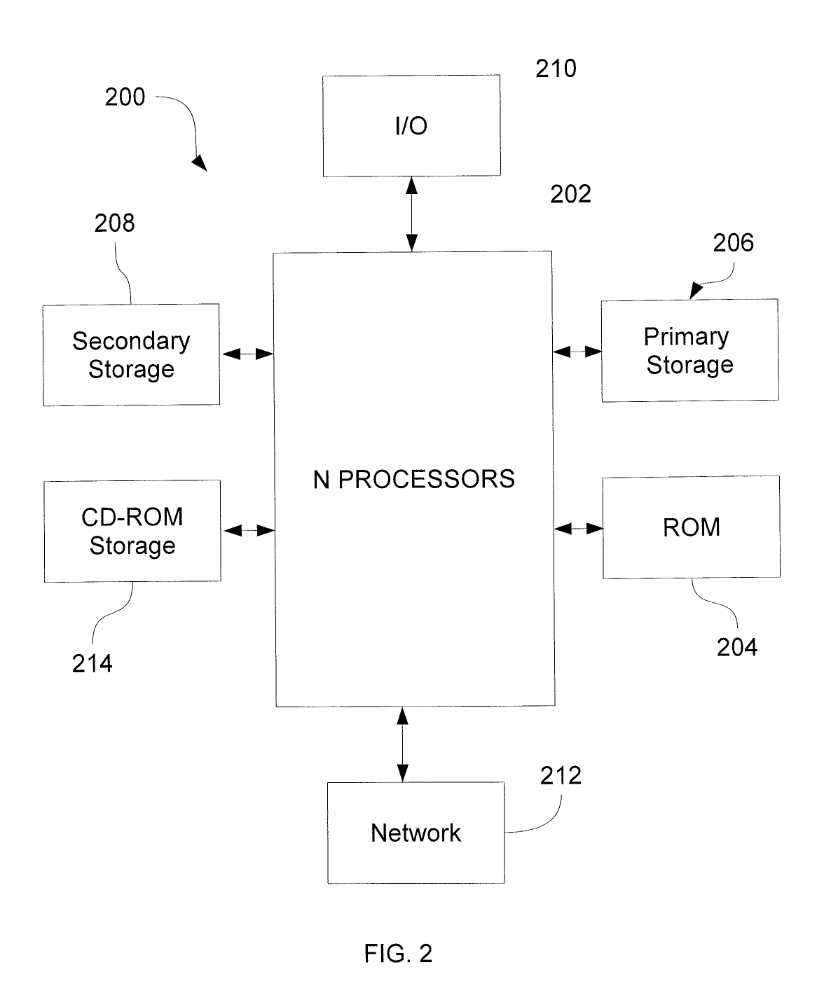

FIG. 2 illustrates a typical computer system that, when appropriately configured or designed, may serve as a computer system 200 for which the present invention may be embodied.

Computer system 200 includes a quantity of processors 202 (also referred to as central processing units, or CPUs) that may be coupled to storage devices including a primary storage 206 (typically a random access memory, or RAM), a primary storage 204 (typically a read only memory, or ROM). CPU 202 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 204 acts to transfer data and instructions uni-directionally to the CPU and primary storage 206 typically may be used to transfer data and instructions in a bi-directional manner. The primary storage devices discussed previously may include any suitable computer-readable media such as those described above. A mass storage device 208 may also be coupled bi-directionally to CPU 202 and provides additional data storage capacity and may include any of the computer-readable media described above. Mass storage device 208 may be used to store programs, data and the like and typically may be used as a secondary storage medium such as a hard disk. It will be appreciated that the information retained within mass storage device 208, may, in appropriate cases, be incorporated in standard fashion as part of primary storage 206 as virtual memory. A specific mass storage device such as a CD-ROM 214 may also pass data uni-directionally to the CPU.

CPU 202 may also be coupled to an interface 210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 202 optionally may be coupled to an external device such as a database or a computer or telecommunications or internet network using an external connection shown generally as a network 212, which may be implemented as a hardwired or wireless communications link using suitable conventional technologies. With such a connection, the CPU might receive information from the network, or might output information to the network in the course of performing the method steps described in the teachings of the present invention.

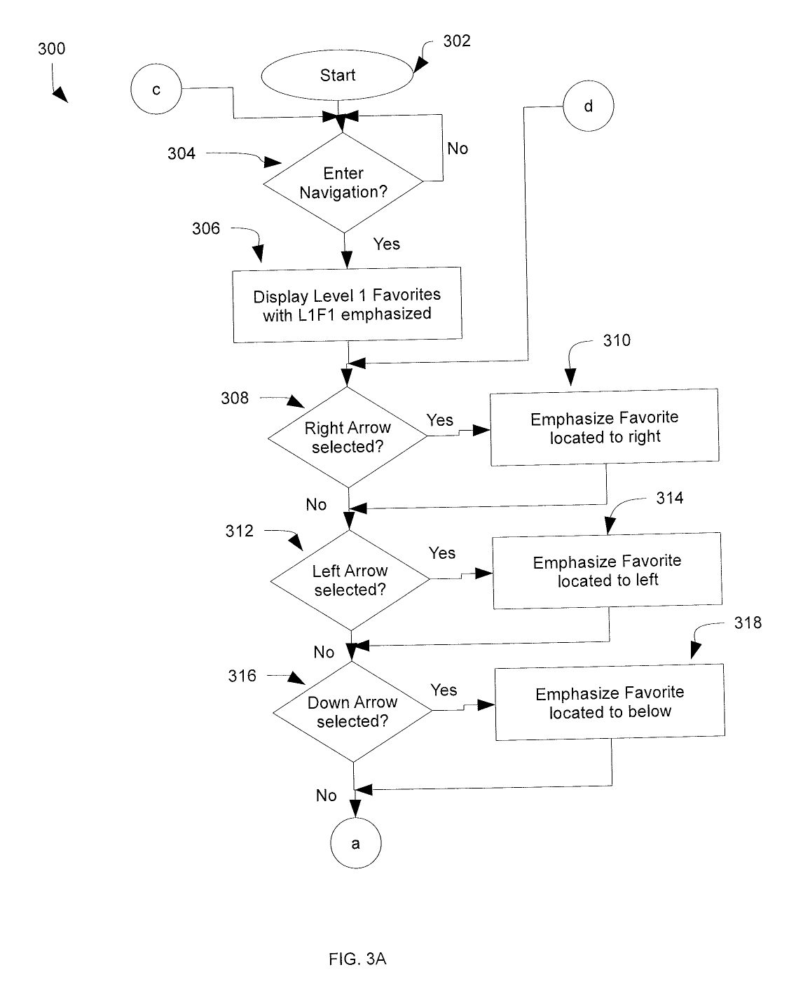

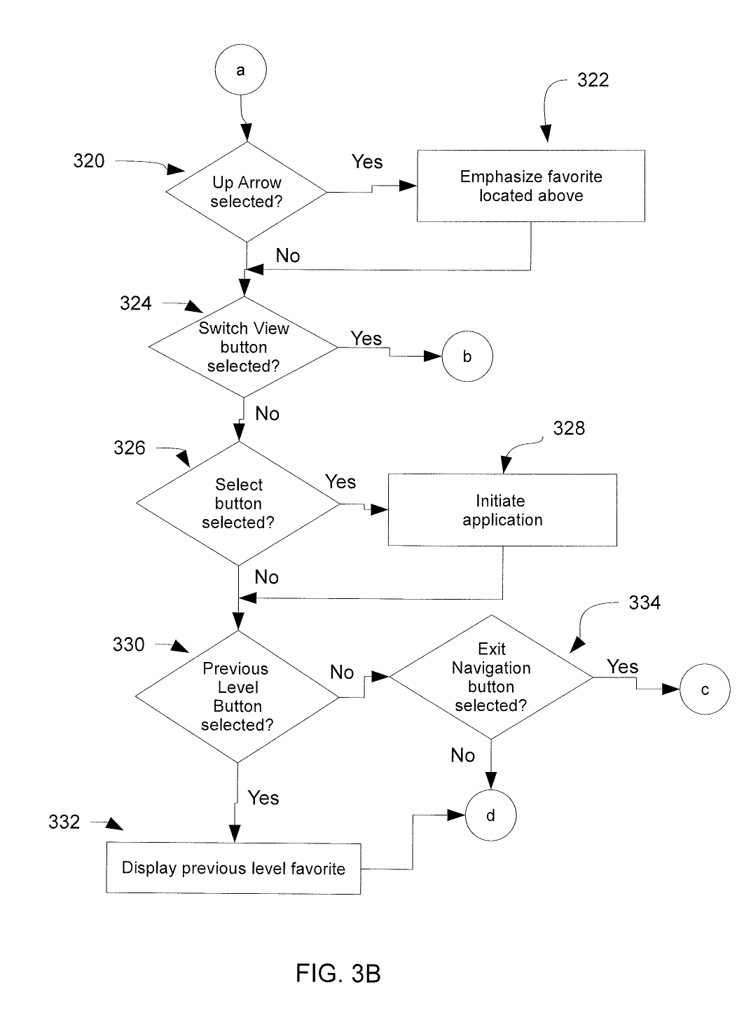

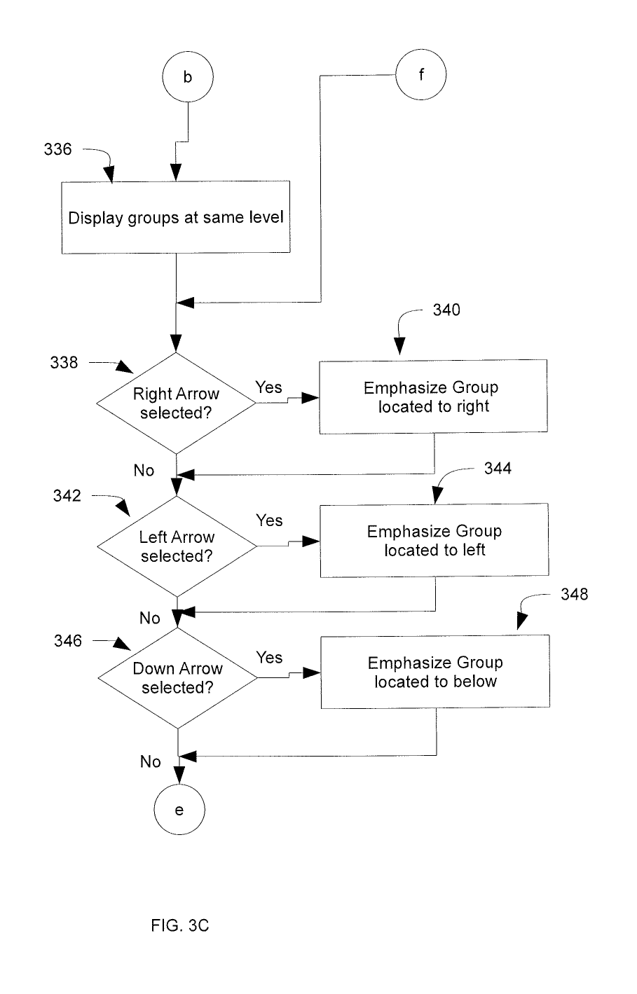

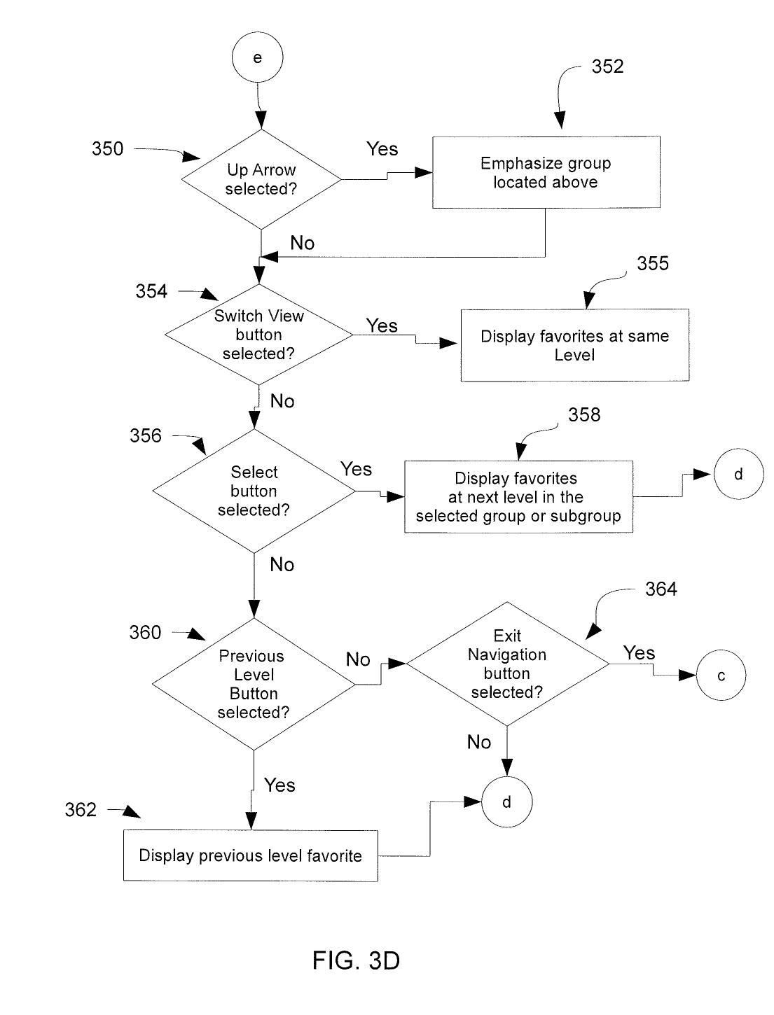

FIGS. 3A-D present a flow chart illustrating a method 300 for a multi-level browsing system for software enabled systems, in accordance with an embodiment of the present invention.

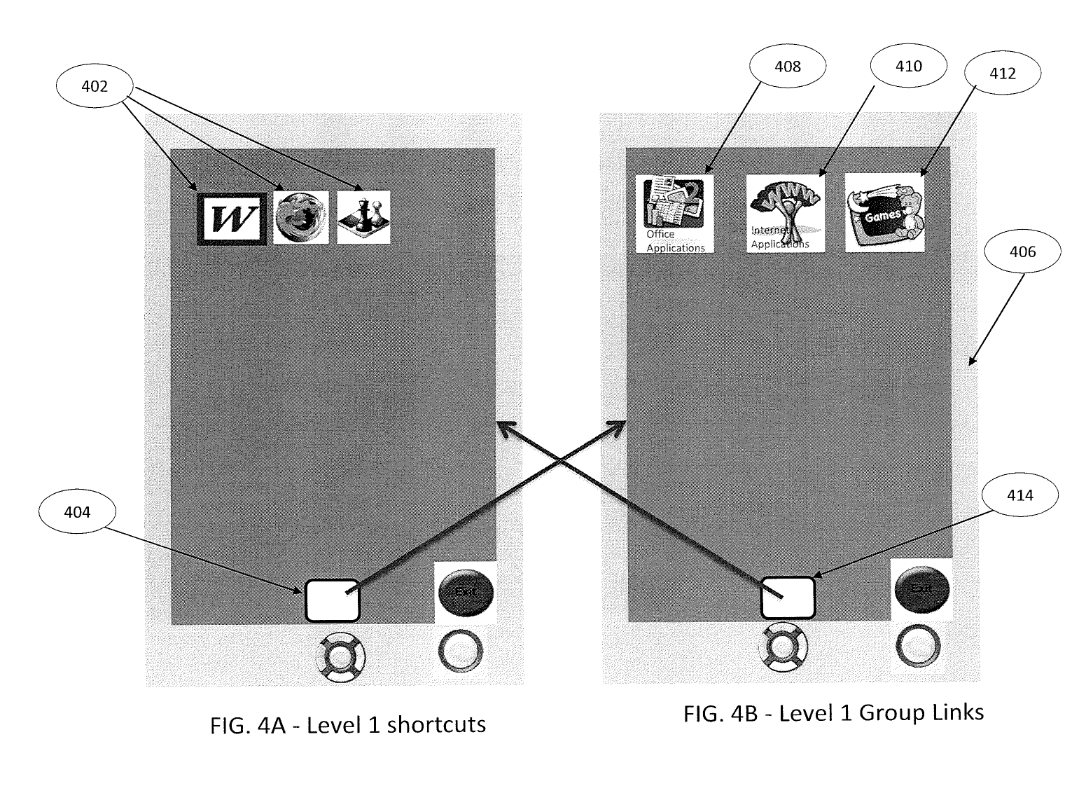

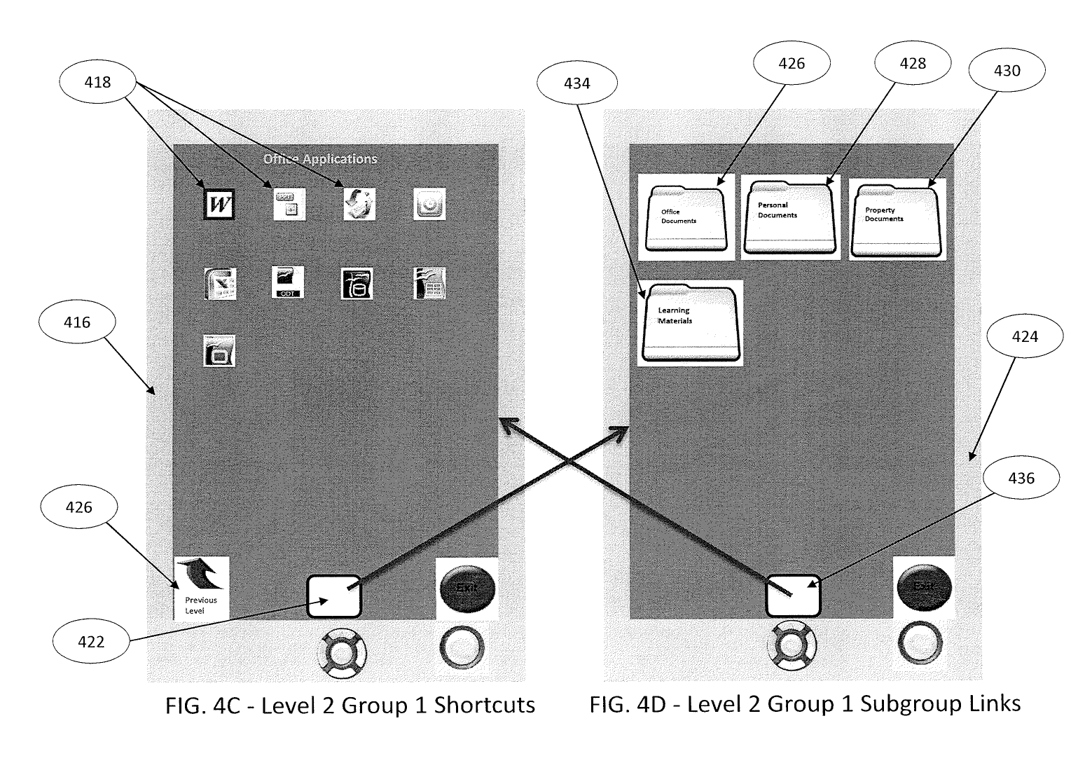

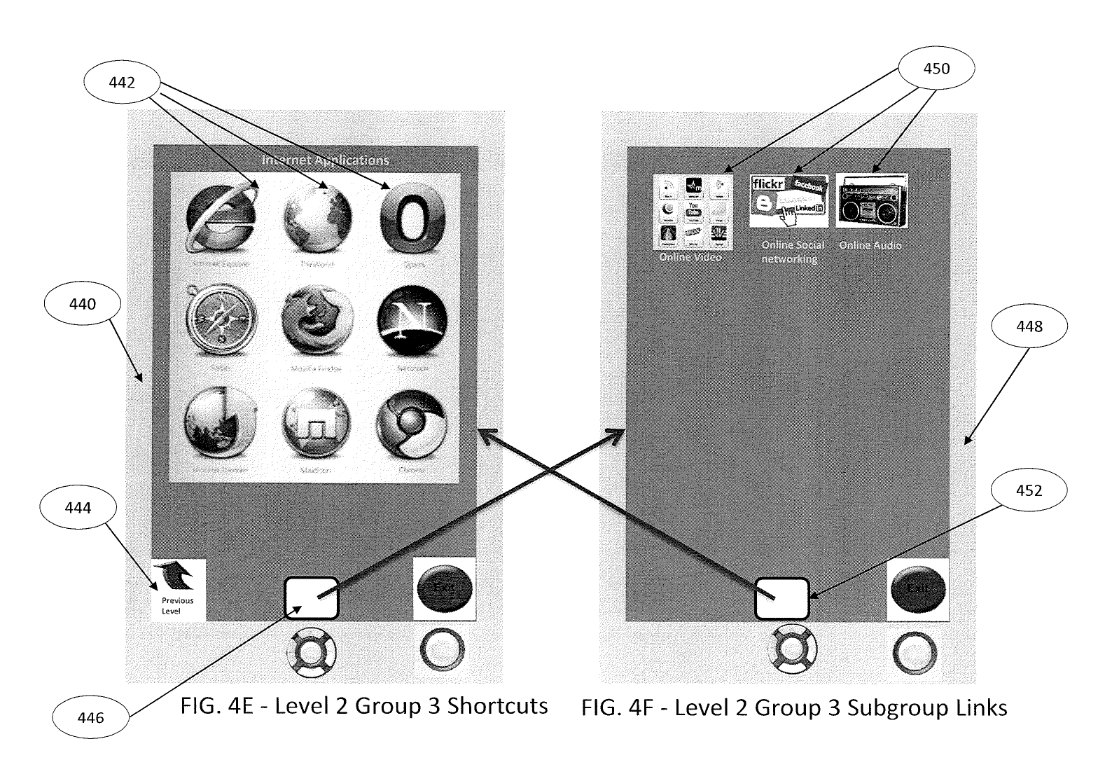

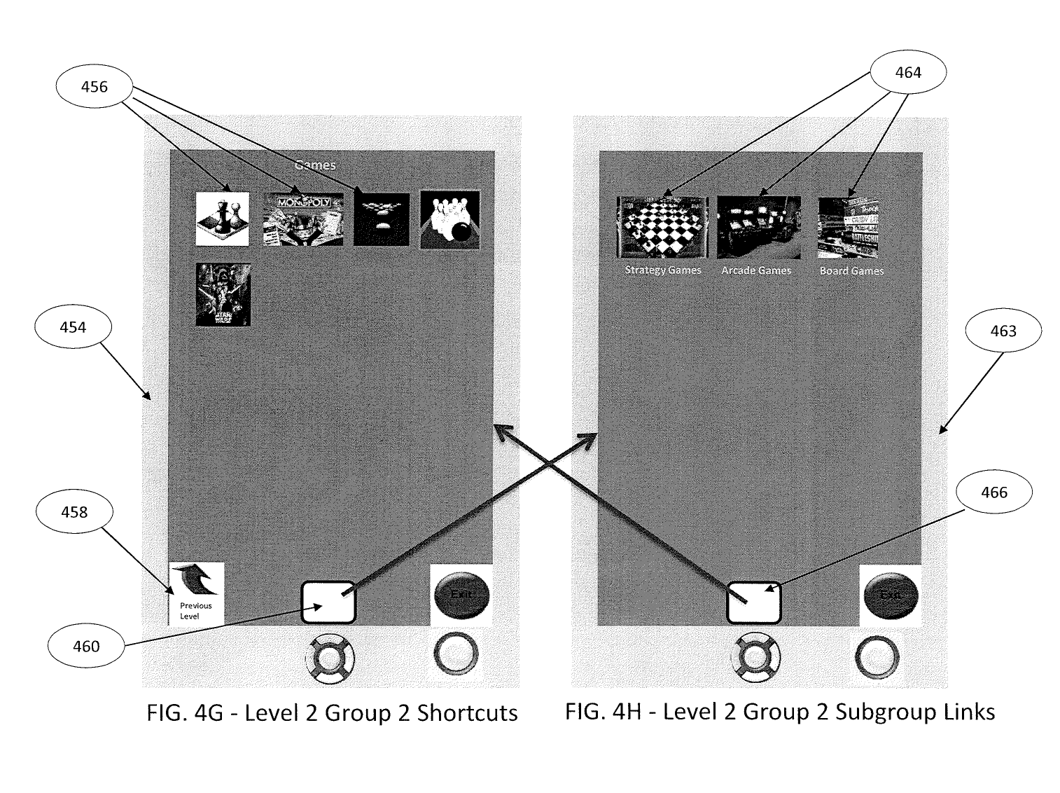

Method 300 may initiate in a step 302 (FIG. 3A). In a step 304, it may be determined whether navigation may be entered. For a determination in step 304 of not entering navigation, execution of method 300 returns to step 304. For a determination in step 304 of entering navigation, in a step 306, level one favorites, as illustrated in FIG. 1A, may be displayed via interface 210 (FIG. 2) (e.g. video monitor) with favorite button 106 (FIG. 1A) highlighted/emphasized. Generally, any time a new display is provided, the top left icon, such as button 106 in FIG. 4A will be highlighted. However, as can be appreciated, this need not be the case, and any one of the icons can initially be highlighted.

In a step 308, it may be determined whether a selection for right navigation button 120 (FIG. 1A) has been executed via interface 210 (FIG. 2) (e.g. touch-sensitive display, button or microphone for verbal command). For a determination in step 308 of a selection for right navigation button 120 (FIG. 1A), in a step 310, the currently highlighted/emphasized button may be unhighlighted/de-emphasized and the button located to the right of the current button may be highlighted/emphasized. For example, for a current button highlighted/emphasized as favorite button 106 (FIG. 1A), an unhighlight/de-emphasis of favorite button 106 (FIG. 1A) would be performed, followed by performance of emphasizing favorite button 107 (FIG. 1A).

For a determination in step 308 of not selecting right navigation button 120 (FIG. 1A), in a step 312 it may be determined whether a selection for left navigation button 116 (FIG. 1A) has been executed. For a determination in step 312 of a selection for left navigation button 116 (FIG. 1A), in a step 314, the currently highlighted/emphasized button may be unhighlighted/de-emphasized and the button located to the left of the current button may be highlighted/emphasized. For example, for a current button highlighted/emphasized as favorite button 107 (FIG. 1A), an unhighlight/de-emphasis of favorite button 107 (FIG. 1A) would be performed, followed by performance of emphasizing favorite button 106 (FIG. 1A).

For a determination in step 312 of not selecting left navigation button 116 (FIG. 1A), in a step 316 it may be determined whether a selection for down navigation button 118 (FIG. 1A) has been executed. For a determination in step 316 of a selection for down navigation button 118 (FIG. 1A), in a step 318, the currently highlighted/emphasized button may be unhighlighted/de-emphasized and the button located below the current button may be highlighted/emphasized. For example, for a current button highlighted/emphasized as favorite button 106 (FIG. 1A), an unhighlight/de-emphasis of favorite button 106 (FIG. 1A) would be performed, followed by performance of emphasizing favorite button 108 (FIG. 1A).

For a determination in step 316 of not selecting down navigation button 118 (FIG. 1A), in a step 320 (FIG. 3B) it may be determined whether a selection for up navigation button 114 (FIG. 1A) has been executed. For a determination in step 320 of a selection for up navigation button 114 (FIG. 1A), in a step 322, the currently highlighted/emphasized button may be unhighlighted/de-emphasized and the button located above the current button may be highlighted/emphasized. For example, for a current button highlighted/emphasized as favorite button 108 (FIG. 1A), an unhighlight/de-emphasis of favorite button 108 (FIG. 1A) would be performed, followed by performance of emphasizing favorite button 106 (FIG. 1A).

For a determination in step 320 of not selecting up navigation button 114 (FIG. 1A), in a step 324 it may be determined whether a selection for switch view button 122 (FIG. 1A) has been executed. For a determination in step 324 of not selecting switch view button 122 (FIG. 1A), in a step 326 it may be determined whether selection button 124 (FIG. 1A) or a favorite button (e.g. favorite button 106 (FIG. 1A)) has been selected. For a determination in step 326 of selecting selection button 124 (FIG. 1A) or selecting a favorite button (e.g. favorite button 106 (FIG. 1A)), selected favorite may be displayed in a step 328. For example, a selection of favorite button 106 (FIG. 1A) or a selection of selection button 124 (FIG. 1A) while emphasizing favorite button 106 (FIG. 1A) may result in the display of information as illustrated in FIG. 1C. Furthermore, selection of a favorite button in step 328 may operate to initiate operation of an application. Non-limiting examples of applications which may be initiated include display of an image and/or video or play audio.

For a determination in step 326 of not selecting selection button 124 (FIG. 1A) and not selecting a favorite button, in a step 330 it may be determined whether previous level button 110 has been executed. For a determination in step 330 of selection of previous level button 110, in a step 332 the previous favorite level may be displayed. For example, for a display of information as illustrated in FIG. 1C and with a previous level as illustrated in FIG. 1A, a selection of previous level button 110 would result in the display of information as illustrated in FIG. 1A. It is important to note that depressing the previous level button 110 would operate to display a previous level of the same type of display. In other words, if a particular display includes the favorite icons, depressing the button 110 would show a previous level of favorites. Similarly, if display 100 was displaying a plurality of group icons, depressing button 110 would display the previous level of group icons. This way, depressing button 110 in FIG. 1C would produce the display in FIG. 1A and not the display in FIG.

1B.

For a determination in step 330 of not selecting previous level button 110, in a step 334 it may be determined whether exit navigation button 112 has been selected. For a determination of selection of exit navigation button 112, execution of method 300 transitions to step 304 (FIG. 3A). For a determination in step 334 of not selecting exit navigation button 112 and following display of previous favorite level in step 332, execution of method 300 transitions to step 308 (FIG. 3A).

For a determination in step 324 (FIG. 3B) of selecting switch view button 122, in a step 336 (FIG. 3C) group buttons for the respective level may be displayed. For example, for a display of information as presented in FIG. 1A, a selection of switch view button 122 may result in the display of information as illustrated in FIG. 1B.

In a step 338, it may be determined whether a selection for right navigation button 120 (FIG. 1B) has been executed. For a determination in step 338 of a selection for right navigation button 120 (FIG. 1B), in a step 340, the currently highlighted/emphasized button may be unhighlighted/de-emphasized and the button located to the right of the current button may be highlighted/emphasized. For example, for a current button highlighted/emphasized as group button 128 (FIG. 1B), an unhighlight/de-emphasis of group button 128 (FIG. 1B) would be performed, followed by performance of emphasizing group button 129 (FIG. 1B).

For a determination in step 338 of not selecting right navigation button 120 (FIG. 1B), in a step 342 it may be determined whether a selection for left navigation button 116 (FIG. 1B) has been executed. For a determination in step 342 of a selection for left navigation button 116 (FIG. 1B), in a step 344, the currently highlighted/emphasized button may be unhighlighted/de-emphasized and the button located to the left of the current button may be highlighted/emphasized. For example, for a current button highlighted/emphasized as group button 129 (FIG. 1B), an unhighlight/de-emphasis of group button 129 (FIG. 1B) would be performed, followed by performance of emphasizing group button 128 (FIG. 1B).

For a determination in step 342 of not selecting left navigation button 116 (FIG. 1B), in a step 346 it may be determined whether a selection for down navigation button 118 (FIG. 1B) has been executed. For a determination in step 346 of a selection for down navigation button 118 (FIG. 1B), in a step 348, the currently highlighted/emphasized button may be unhighlighted/de-emphasized and the button located below the current button may be highlighted/emphasized. For example, for a current button highlighted/emphasized as group button 128 (FIG. 1B), an unhighlight/de-emphasis of group button 128 (FIG. 1B) would be performed, followed by performance of emphasizing group button 130 (FIG. 1B).

For a determination in step 346 of not selecting down navigation button 118 (FIG. 1B), in a step 350 (FIG. 3D) it may be determined whether a selection for up navigation button 114 (FIG. 1B) has been executed. For a determination in step 350 of a selection for up navigation button 114 (FIG. 1B), in a step 352, the currently highlighted/emphasized button may be unhighlighted/de-emphasized and the button located above the current button may be highlighted/emphasized. For example, for a current button highlighted/emphasized as group button 130 (FIG. 1B), an unhighlight/de-emphasis of group button 130 (FIG. 1B) would be performed, followed by performance of emphasizing group button 128 (FIG. 1B).

For a determination in step 350 of not selecting up navigation button 114 (FIG. 1B), in a step 354 it may be determined whether a selection for switch view button 122 (FIG. 1B) has been executed. For a determination in step 354 of not selecting switch view button 122 (FIG. 1B), in a step 356 it may be determined whether selection button 124 (FIG. 1B) or a group button (e.g. group button 128 (FIG. 1B)) has been executed. For a determination in step 356 of selecting selection button 124 (FIG. 1B) or selecting a group button (e.g. group button 128 (FIG. 1B)), selected group may be displayed in a step 358. For example, a selection of group button 128 (FIG. 1B) or a selection of selection button 124 (FIG. 1B) while emphasizing group button 128 (FIG. 1B) would result in the display of information as illustrated in FIG. 1D.

For a determination in step 356 of not selecting selection button 124 (FIG. 1B) and not selecting a group button, in a step 360 it may be determined whether previous level button 110 has been selected. For a determination in step 360 of selection of previous level button 110, in a step 362 the previous group level may be displayed. For example, for a display of information as illustrated in FIG. 1D and with a previous level as illustrated in FIG. 1B, a selection of previous level button 110 would result in the display of information as illustrated in FIG. 1B. As previously explained, selecting the previous level button would allow the display to show icons of the same kind. Therefore, depressing the button 110 in FIG. 1D would then display the icons shown in FIG. 1B, since both of these figures display group icons.

For a determination in step 360 of not selecting previous level button 110, in a step 364 it may be determined whether exit navigation button 112 has been selected. For a determination of selection of exit navigation button 112, execution of method 300 transitions to step 304 (FIG. 3A). For a determination in step 364 of not selecting exit navigation button 112 and also following display of previous group level in step 362, execution of method 300 transitions to step 338 (FIG. 3C).

For a determination in step 354 (FIG. 3D) of selecting switch view button 122, in a step 355 level buttons for the respective level may be displayed. For example, for a display of information as presented in FIG. 1B, a selection of switch view button 122 may result in the display of information as illustrated in FIG. 1A.

FIGS. 4A-4H illustrate typical displays shown in more detail than those with respect to FIGS. 1A-1F.

As previously indicated, each of the “favorite” software programs, applications or files would be assigned a particular icon. For example, the display 400 shown in FIG. 4A includes three “favorite” icons 402 associated with various software programs, applications or files such as Word or Internet Explorer. These files would be immediately initiated by the user either depressing the particular icon if the display includes a touch screen, or the selection button 124 after the utilization of the navigation buttons 114, 116, 118, and 120 as shown in FIGS. 1A-1F. If the Level 1 shortcut icons shown in FIG. 4A do not include the appropriate software program, application or file, the user would depress button 404 allowing display 406 to be displayed as shown in FIG. 4B. This display includes a plurality of icons 408, 410, 412, each of the icons designating a specific grouping of related software programs, applications or files. For example, icon 408 is directed to office applications, icon 410 is directed to internet applications and icon 412 is directed to games. If after the user reviews the icons shown in display 406, by depressing button 414, the user can return to the Level 1 shortcut icon display as shown in FIG. 4A. It is important to note that buttons 404 and 414 would allow an individual to navigate between favorite icons and group icons on the same level.

By depressing icon 408 relating to office applications, a plurality of icons 418 relating to various office applications will be shown on display 416 shown in FIG. 4C. The user would then have the ability of activating any of the office applications shown on display 416 by depressing the appropriate icon button or utilizing the navigation buttons shown in FIGS. 1A-1F. Knowledge of the appropriate directory address of that program by the computer, would allow this program to be displayed. The user can return to the previous level shown in FIG. 4B by depressing icon 420. Alternatively, the user can, by depressing button 422, display additional subgroup links on display 424 such as shown by icons 426, 428, 430 and 434 of FIG. 4D. Depressing any of the icons 426, 428, 430 and 434 would generate another display (not shown) including another series of icons relating to the particular group that was depressed. Depressing button 436 in FIG. 4D would return the screen to display 416 in FIG. 4C.

FIG. 4E shows the icons 442 of display 440 that would be displayed based upon icon 410 in FIG. 4B being depressed. This display also includes a button 444 to return to the level shown in display 406, or to illustrate additional links by depressing button 446. These additional links are shown in display 448 of FIG. 4F. This figure includes a plurality of icons 450 as well as a button 452 which, when depressed, would allow the user to return to the display shown in FIG. 4E. It is noted that the icons 450 all relate to various online software programs, applications or files.

FIG. 4G shows the icons that would be displayed when icon 412 of display 406 is depressed. These icons will be displayed on display 454 and, similar to a number of the previous displays, button 458, when depressed would allow the user to return to the previous level. Buttons 460 in FIG. 4G and 466 in FIG. 4H, when depressed, would allow the user to return to the alternate display. As shown in FIG. 4H, icons 464 relate to various types of games.

Although not specifically illustrated in FIGS. 4A-4H, each respective display could include various navigation buttons, allowing the particular icons shown in a display to be highlighted. When this occurs, a separate selection button would be depressed to allow a selected software program, application or file to be displayed or, alternatively, to allow another display of group linked icons.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Having fully described at least one embodiment of the present invention, other equivalent or alternative methods of providing multi-level browsing for interacting with a display of information according to the present invention will be apparent to those skilled in the art. The invention has been described above by way of illustration, and the specific embodiments disclosed are not intended to limit the invention to the particular forms disclosed. For example, the particular implementation of the organization of screen display portion 102 (FIG. 1A) and border portion 104 (FIG. 1A) may vary depending upon the particular type GUI device used. The information presented via GUIs described in the foregoing was directed to mobile device implementations; however, similar techniques may be directed to stationary devices. Implementations of the present invention are contemplated as within the scope of the present invention. The invention is thus to cover all modifications, equivalents, and alternatives falling within the spirit and scope of the following claims.

1. A method for multi-level browsing, comprising the steps of:
organizing a plurality of software programs, applications and files stored on a medium into a first group and a second group, each member of said first group being an individual software program, application or file, each of said members of said first group assigned a unique directory address and a first icon, each of said members of said second group representing a plurality of software programs related to one another, applications related to one another or files related to one another, each of said software programs, applications and files of said second group having a unique directory address, each of said members of said second group assigned a second icon;
displaying a first set of said first icons of said first group as a first distinct display on a display screen;
reviewing said first set of icons;
subsequently displaying a first set of said second icons of said second group as a second distinct display on said display screen when none of said first icons was selected; and
selecting one of said first or second icons;
wherein when one of said first set of said first icons is selected, the software program, application or file associated with said directory address of the selected icon would be activated, and further wherein one of said first set of second icons is selected, a second set of said first icons representing the related software programs, applications or files of said selected second icon would be displayed on said display screen.

2. The method in accordance with claim 1, including the steps of continuing to display additional sets of said first icons on displays on said display screen distinct from the displays of said second icons on said display screen.

3. The method in accordance with claim 2, including the steps of alternating the display of said additional sets of said first icons as distinct displays with respect to the distinct displays of said additional sets of said second icons.

4. The method in accordance with claim 1, wherein said selecting step is accomplished by touching said one of said first or second icons.

5. The method in accordance with claim 1, including the step of highlighting one of said first or second icons.

6. The method in accordance with claim 5, including the step of utilizing one or more navigation buttons associated with said display screen to individually highlight said first and second icons.

7. The method in accordance with claim 6, including the step of touching a separate selection button to select a highlighted first or second icon.

8. The method in accordance with claim 1, including the step of utilizing a view selection button to allow the user to select a display including a portion of said first icons or a portion of said second icons.

9. The method in accordance with claim 1, including the step of depressing an exit button.

10. A system for multi-level browsing through a plurality of software programs, applications or files comprising:
a first means for organizing a plurality of software programs, applications and files stored on a medium into a first group and a second group, each member of said first group being an individual software program, application or file having a unique directory address and a first icon, each member of said second group encompassing a plurality of related software programs, applications or files, each member of said group assigned a second icon, each of said software programs, applications and files in said second group having a unique directory address;
a second means for displaying a first set of said first icons of said first group as a first distinct display on a display screen and displaying a first set of said second icons of said second group as a second distinct display on said display screen; and
a third means for selecting one of said first or second icons;
wherein when one of said first set of first icons is selected, the software program, application or file associated with said directory address would be activated, and when one of said first set of said second icons is selected, a second set of first icons representing the related software programs, applications or files associated with the selected second icon would be displayed on said display screen.

11. The system in accordance with claim 10, wherein said second means displays additional sets of said first icons as displays on said display screen distinct from the displays of said second icons on said display screen.

12. The system in accordance with claim 11, wherein said second means alternates the display of said additional sets of said first icons as distinct displays with respect to the distinct displays of said additional sets of said second icons.

13. The system in accordance with claim 10, wherein said third means is a touch screen display, wherein touching one of said first icons would activate a software program, application or file associated with said first icon, and touching one of said second icons would display a second set of said first icons.

14. The system in accordance with claim 13, wherein said third means highlights said first and second icons.

15. The system in accordance with claim 10, wherein said third means includes one or more navigation buttons to highlight said first and second icons.

16. The system in accordance with claim 15, wherein said third means includes a selection button to select a highlighted first or second icon.

17. The system in accordance with claim 10, wherein said third means includes a view selection button for allowing a user to select a display including a portion of said first icons or a portion of said second icons to be displayed on said display screen.

18. The system in accordance with claim 10, further including an exit button.
